(19) United States
(12) Patent Application Publication
(10) Pub. No.: US 2016/0135430 A1
(43) Pub. Date: May 19, 2016

(54) MULTI-FUNCTIONAL ADAPTABLE PET LEASH

(71) Applicant: Mark Noonan, New Canaan, CT (US)

(72) Inventor: Mark Noonan, New Canaan, CT (US)

(21) Appl. No.: 14/945,029

(22) Filed: Nov. 18, 2015

Related U.S. Application Data
(60) Provisional application No. 62/123,524, filed on Nov. 19, 2014.

(51) Int. Cl. A01K 27/00

(52) U.S. Cl. CPC A01K 27/004

(57) ABSTRACT

An exemplary embodiment of a leash generally includes an elastic core and at least one loop or eyelet having an opening that allow an extra clip to be attached near the handle. The clip may be used to selectively gather a portion of the leash in a loop to thereby shorten the effective length of the leash. The extra clip may be used to attach the leash to an object without detaching the leash from the pet's collar. Both ends of the leash may have hooks for releasable attachment to a pet collar and/or to a handle. The handle may also be attached to a loop in the middle of the leash for converting the leash into two shorter connected leashes for walking two pets. A single handle may further be attached to two leashes to allow four pets to be walked concurrently and tangle-free while using the single handle.

### CROSS-REFERENCE TO RELATED APPLICATION

This application claims the benefit of and priority to U.S. Provisional Application Ser. No. 62/123,524 filed Nov. 19, 2014. The entire disclosure of this patent application is incorporated herein by reference in its entirety.

### FIELD

The present disclosure generally relates to an adapter system to manage slack in a leash, such as while walking a dog. Further, the present disclosure also generally relates to leashes for walking multiple pets simultaneously (e.g., a two-pet leash, etc.) and other functioning leashes.

### BACKGROUND

This section provides background information related to the present disclosure which is not necessarily prior art.

It is common practice for owners of dogs and other pets to regularly walk or exercise their pets. Proper control of the pet and laws of many municipalities require that pets be restrained by a leash. Typically, the leash is a piece of material with a handle to be held by the owner or pet walker and a clip for attachment to the pet's collar. For standard leashes, there is generally a trade-off between longer leashes and more difficulty managing the extra slack. Many pet owners own more than one leash of varying lengths, each to be used in various settings/environments best suited to the leash length (e.g., in crowds, cities, etc. tend to be better suited for shorter leashes). Mechanical spooled leashes exist, yet require more operator attention and have other benefits as well as trade-offs. For example, the operator's hand that holds the leash generally is fully occupied, rapid leash/pet retraction can be difficult in emergencies, and abrupt stops as the gears engage or reach the maximum leash length is reached.

While there are many variations of leashes, bungee-style leashes incorporate an internal stretchable woven or rubber cable typically inside a woven nylon mesh tube. Bungee leashes generally provide stretch up to 30% or so of the slack length. But meaningful and increasing forces are typically required to stretch the leash out. This exerted force can be undesirable by training the pet to pull against the leash when being walked.

While there are some leashes designed to walk two pets with one handle, these conventional leashes have a “Y” or “T” shaped design where the second collar attachment point attaches to the main leash somewhere along the main leash. The second collar attachment point is often closer to the first collar attachment point though it may also be near the handle. Such Y or T shaped designs are only useable when two pets are walked and more often connect the pets laterally on shorter ‘non-shared’ leash sections, making them more prone to tangling and/or more difficult for the pets to change their relative positions while walking.

### DRAWINGS

The drawings described herein are for illustrative purposes only of selected embodiments and not all possible implementations, and are not intended to limit the scope of the present disclosure.

FIG. 1 shows an exemplary embodiment of a leash including two loops along its length and a spring clip or self-closing clip located near the base of the handle. In this example, the handle attaches or connects to the main leash length, which is shown at rest or retracted/un-stretched with an exemplary length of about 2 feet. The extra clip on the “handle end” of the body is located at the distal end of the leash near the end of the main body of the leash.

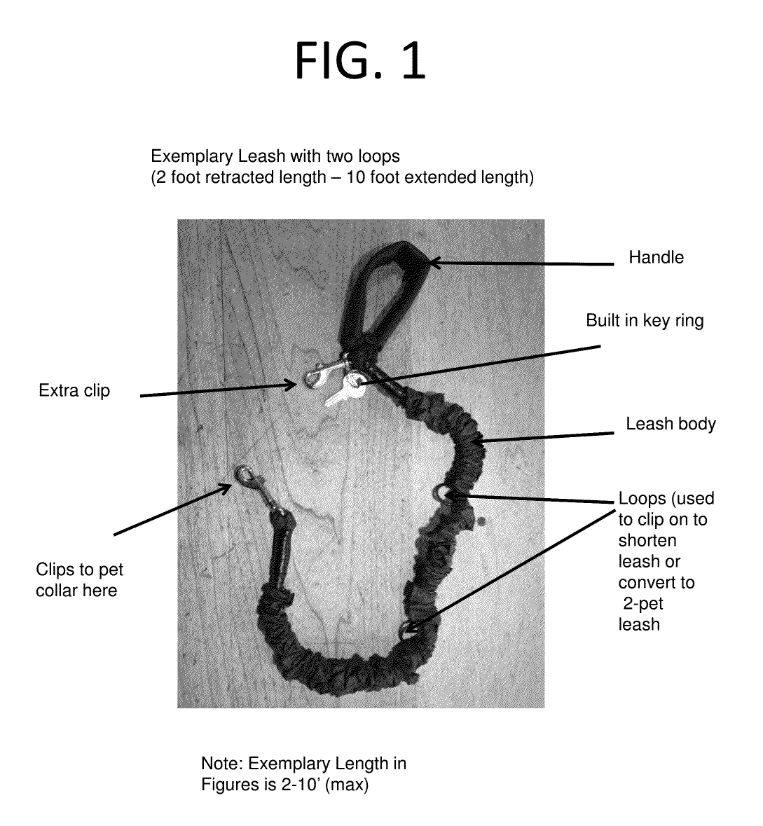

FIGS. 2A-C show an exemplary embodiment of a leash including a detachable handle section that includes a removable extra clip which attaches to the main body or at other locations. FIG. 2A shows the leash configured in the middle or second longest length configuration of the three different leash lengths in this exemplary embodiment. In FIG. 2A, the extra clip is attached or clipped to the loop nearest the main leash body. FIG. 2B shows the leash in the shortest leash length with the extra clip attached or clipped to the loop closest to the clip that attached or secures to the pet's collar. FIG. 2C shows the leash in the same configuration as FIG. 2B being shown ‘in use’ with handle looped over a hand and leash extended. In this exemplary embodiment, the ‘shortest’ length configuration provides for an approximately 3 foot extended length leash.

FIGS. 3A-D show various other elements and configurations of an exemplary embodiment of a leash. The bottom leash in FIG. 3A is shown with the detachable handle connected to the leash main body as in FIG. 2A. The upper leash in FIG. 3A is shown with the detachable handle repositioned on one of the two loops in the main body to provide a configuration whereby two pets can be walked with the one leash with the second pet's collar attached to the ‘extra’ clip. FIG. 3B shows an exemplary embodiment of the leash with the detachable handle now removed or detached from the leash, which also includes an extra clip, two loops on the main leash body, and integrated key ring. FIG. 3C shows the leash in use with a key installed on key ring. FIG. 3D shows the leash in use and mostly extended in a two-pet configuration while walking two dogs.

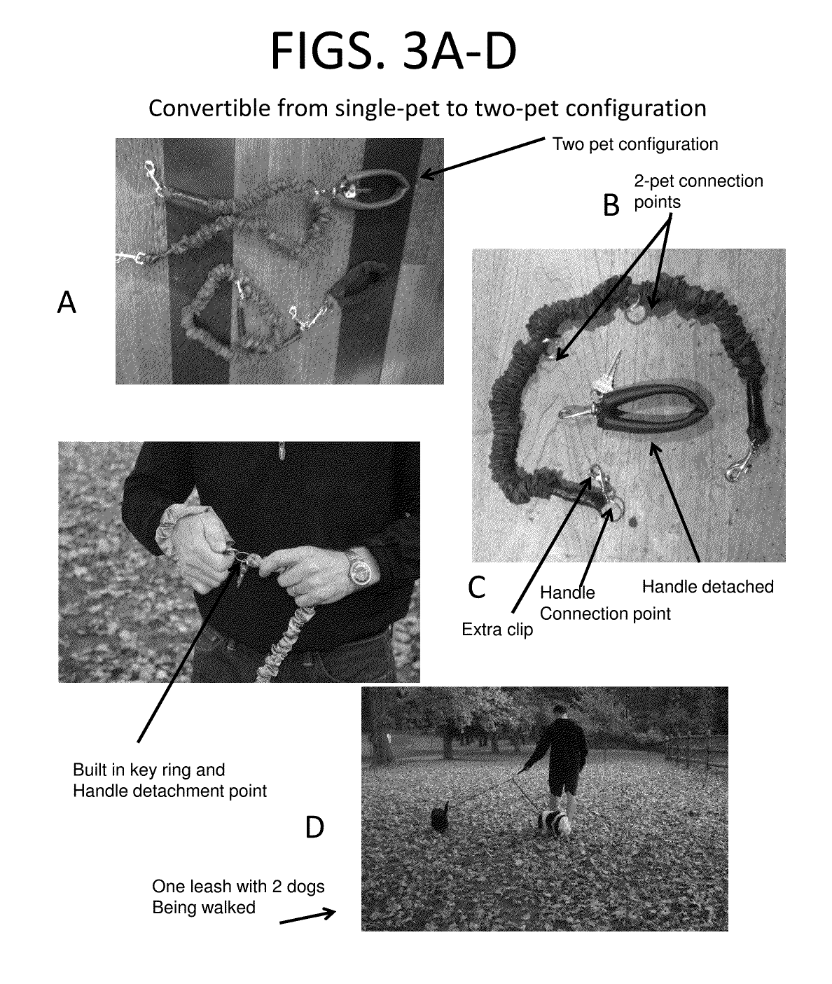

FIGS. 4A-C show some of the additional functionality provided by the integrated extra clip and key ring, such as with a clip-on carry bag (FIG. 4A), with a key on the key ring and a cleanup bag held in the ring (FIG. 4B), and with a bottle clipped to the clip (FIG. 4C).

FIGS. 5A-C show additional exemplary uses and functions of the extra clip to allow the leash to attach to objects, such as to a user's wrist (FIG. 5A), a car door handle (FIG. 5B), and a tree (FIG. 5C).

FIGS. 6A and 6B show the exemplary manner in which other objects may be attached to the leash when the handle is not attached and also showing how the extra clip enables a loop to be formed by using the clip to clip around an object and onto the leash body, such as the user's hand (FIG. 6A) and an umbrella (FIG. 6B).

FIGS. 7A-C show three images of an exemplary leash in various degrees of extension, with FIG. 7C shown nearly at full extension of approximately 10 feet.

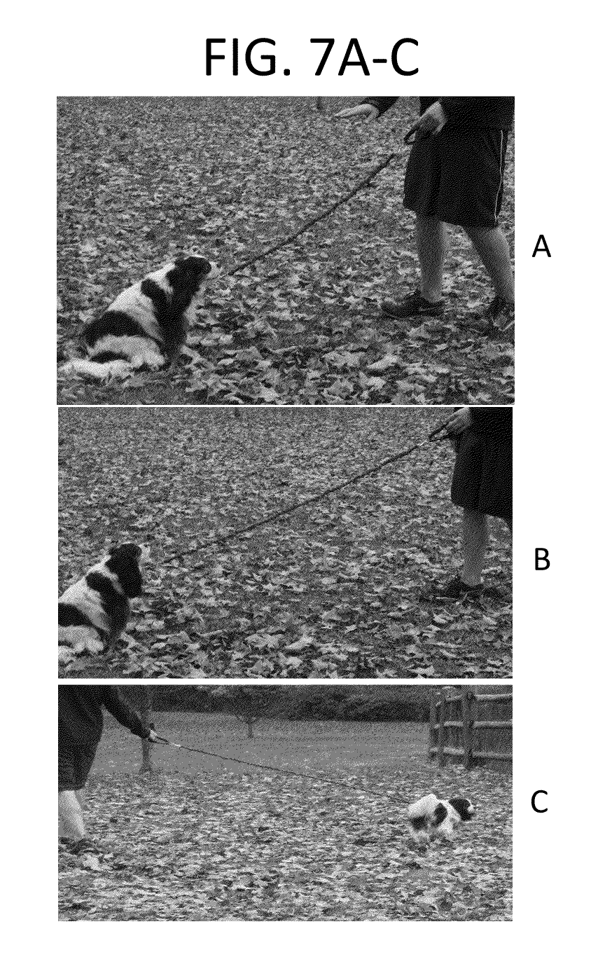

FIGS. 8A and 8B show an exemplary construction of the inner (e.g., molded, cast, etc.) elastomer part of the leash according to an exemplary embodiment in which an internal elastomer is threaded through a tube and secured at each end to hardware and where the elastomer may have an initial unstretched length of about 14 inches and be capable of being stretched to about 10 feet.

### DETAILED DESCRIPTION

Example embodiments will now be described more fully with reference to the accompanying drawings.

According to various aspects, exemplary embodiments are provided of a leash to manage slack and provide other functionality and conveniences. In an exemplary embodiment, a device may comprise thermoplastic rubber or thermoplastic resin material inside or within an outer sheath or tube made of a thin, light-weight, durable material (e.g., ripstop nylon, etc.).

The present disclosure describes a non-mechanical retractable leash whose design enables the leash to effectively provide the function of several types of leashes, requiring only minor adjustments, changes or reconfigurations to switch between or enable these additional built-in functions. In a preferred embodiment, the leash is constructed with a lightweight sheath and a stretchable elastomer with relatively low resistance and high stretch ratio (e.g., 6:1 or higher, etc.). The outer fabric or material is roughly constructed as a long tube with the elastomer inside. The leash handle may be constructed with a non-stretch material or tube. But the leash handle may also have some degree of extension/stretch in some exemplary embodiments to allow for easier insertion and removal of hands through the leash handle. The leash handle may be constructed with material similar to the main, stretchy/extendable portion of the leash in some exemplary embodiments.

As disclosed herein, the leash is configured such that the leash may be quickly and selectively set to any one of two or more lengths (e.g., from 3 feet to maximum of 10 feet or more, etc.). This might be enabled by an additional clip (e.g., gated, spring clip or otherwise, etc.) incorporated into both ends of the leash body such that there is an extra clip at the end of the leash where the handle is located. This extra clip may be clipped to one or more of the reattachment points (e.g., steel rings, etc.) for shortening the effective or working length of the leash by creating temporary loops or gathers in the body of the leash. Such loops along the length of the leash are also used for shortening the maximum or working length of the leash. The leash might also include a detachable handle section that could be reattached at one or more potential reattachment points in the center of the leash (e.g., via installed steel loops, grommets or other devices, etc.), enabling the leash to function as a “two-pet” leash to walk two pets from a single handle or even clip two leashes together in a similar manner to one handle and walk up to 4 pets without tangling or catching.

In various exemplary embodiments, the leash is comprised of various lengths. In an exemplary embodiment, the finished length of the leash might be 10 feet (304.8 centimeters) in length. A variety of design elements working together enable the leash to perform a wide variety of functions otherwise available in several types of leashes separately.

In a preferred embodiment, the leash includes several loops or connection points along its length, as well as a corresponding clip built on the distal end of the leash body. The distal end is connected to the handle that enables the clip to selectively attach to one of the loops built into the main body. The long length extends and contracts and incorporates the elastomer inside the fabric—or other material-tube of the leash. The leash is also designed with a generally longer body or length than average leashes. In an exemplary embodiment, the leash is 10 feet long when fully extended. This provides part of the multi-function and multi-leash capability. The leash also incorporates a design and construction elements whereby the leash body contracts and extends by utilizing an integrated, internal elastomer. In exemplary embodiments, the specialized elastomer provides or has at least the following features that are unique as compared to conventional bungee-style leashes. For example, the elastomer allows the leash to contract to a much shorter length than its fully extended maximum length by several times. The elastomer requires very little force to extend or stretch the elastomer, and consequently the leash. The elastomer also allows lighter fabrics or materials to be used for the leash that will retract and “accordion” more readily with less force.

Other specific elements provide a range of added function and versatility of the leash in exemplary embodiments. For example, the combination of an extra locking clip at the leash body's distal end and small loops spaced along the leash body enable the operator to selectively alter the working length of the leash by clipping the extra locking clip to one or another of the loops along the leash body. In so doing, loops or gathers in the leash body are created between the clip and the loop being clipped to shorten the working length of the leash body.

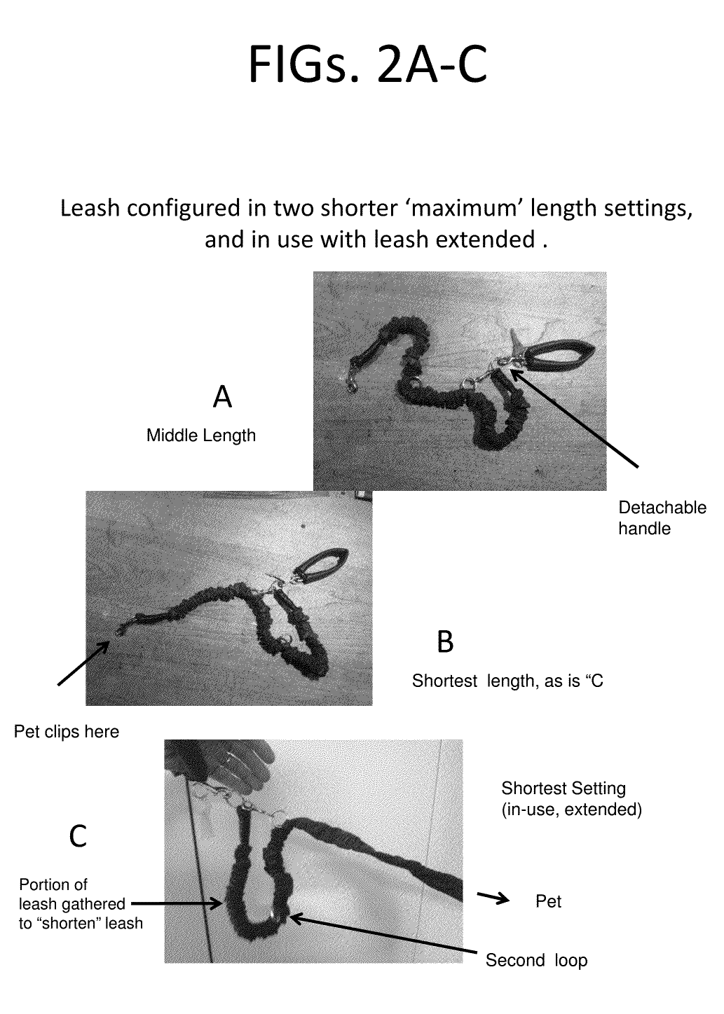

As another example, the high elasticity of the leash body's loops or gathers as shown in FIGS. 2A-C do not create loops long enough to cause tangle risks where the leash might get caught under foot even if such a ‘gather’, for example, might be as much as 7 feet long of working length when extended. Importantly, this allows shortening of the leash without creating long, hanging, or loose loops that could catch or hook on things. In contrast, just having a second handle somewhere mid-way along the length of the leash would tend to present risks of catching on branches or other objects while walking a pet on a two-handled leash.

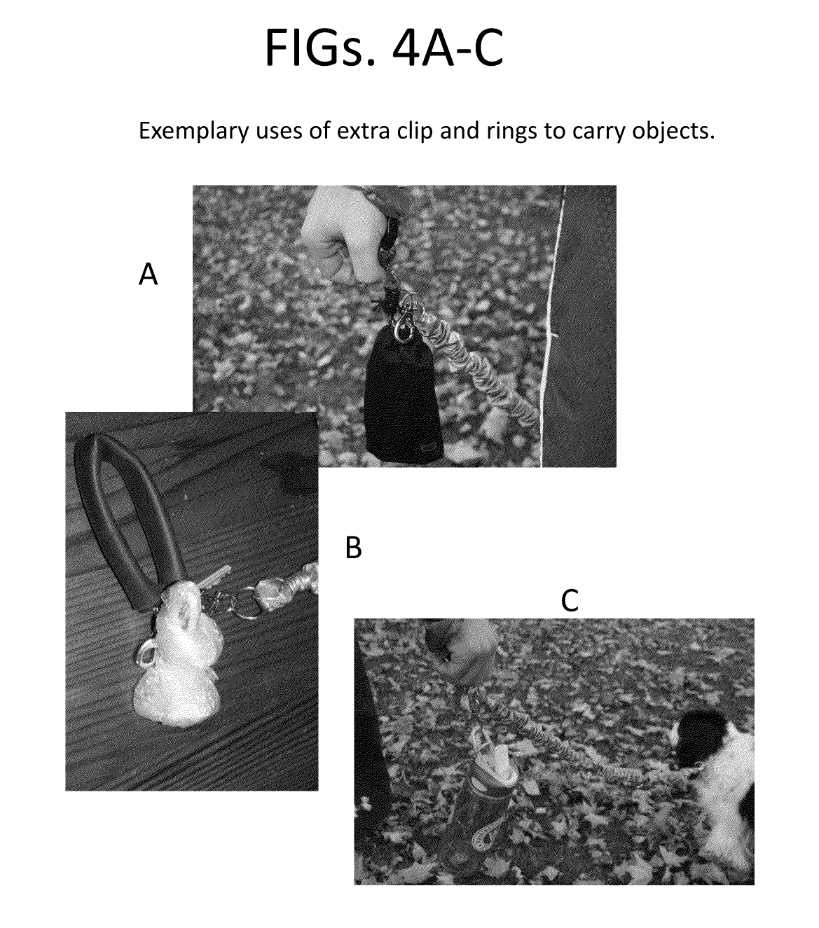

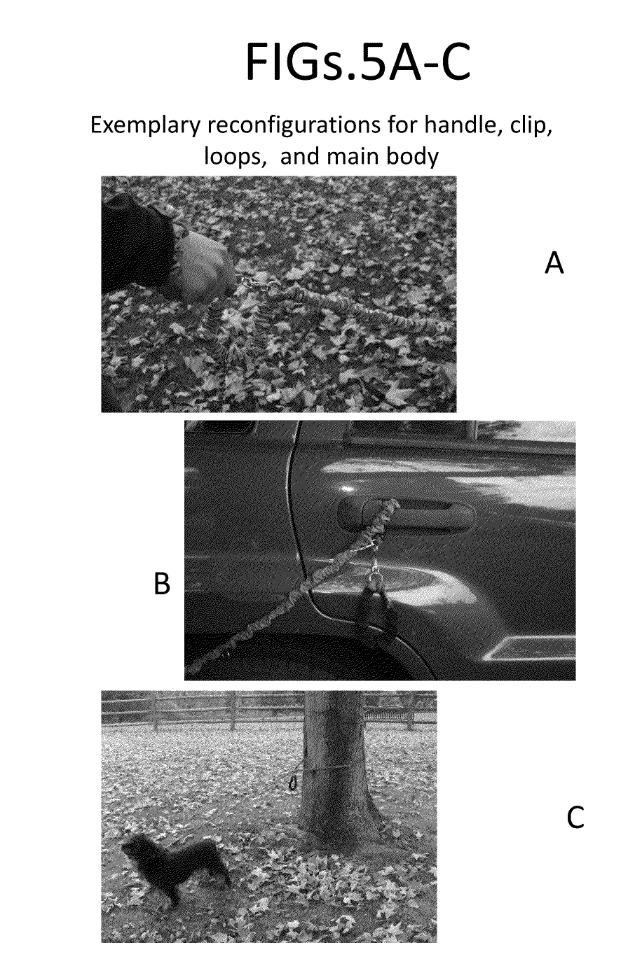

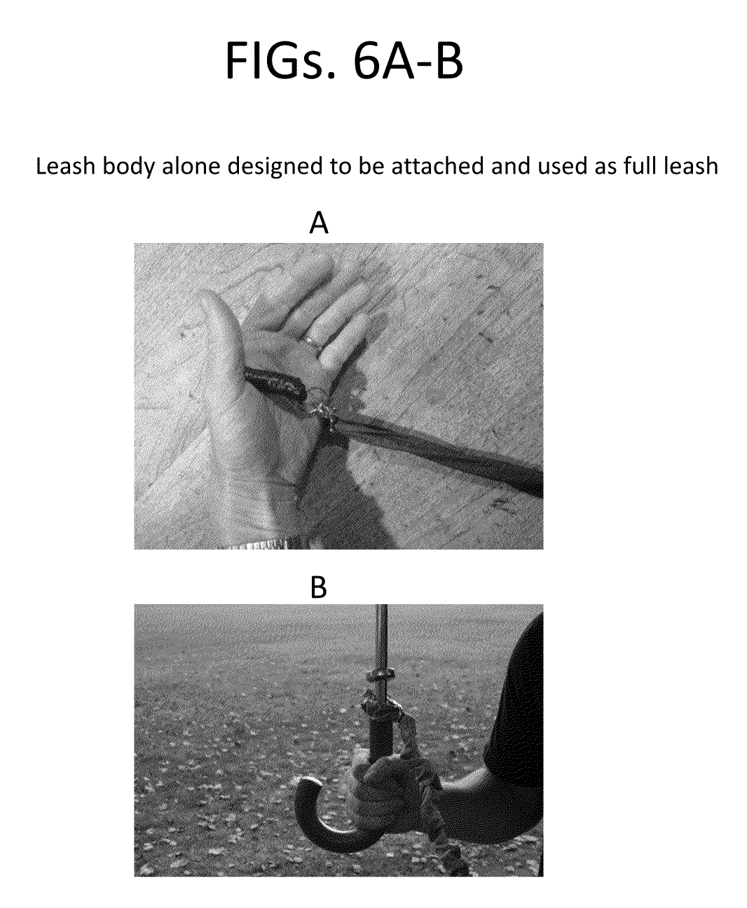

Further, the additional clip incorporated into the leash's distal end adds some additional functions otherwise not provided by pet leashes. First, and as shown in FIGS. 4A-C and 5A, the clip can attach or clip on to items to be carried hands free. More significantly, the leash can then be securely attached around a pole, bench arm/leg, or other objects, such as a car door handle (FIG. 5B), a tree (FIG. 5C), a user's hand (FIG. 6A), and umbrella handle (FIG. 6B). Note that in FIGS. 5B, 5C, and 6B, the leash body alone is used, whereby the leash is wrapped around an object such as a tree, post, or umbrella handle then re-clipped to the leash body or even one of the loops. Not shown is a use wherein the leash could be wrapped around an operator's waist, for example, with the handle removed, and used to walk, jog, or bike totally hands free without risk of the leash tangling under foot of the pet, operator, or even if riding a bike.

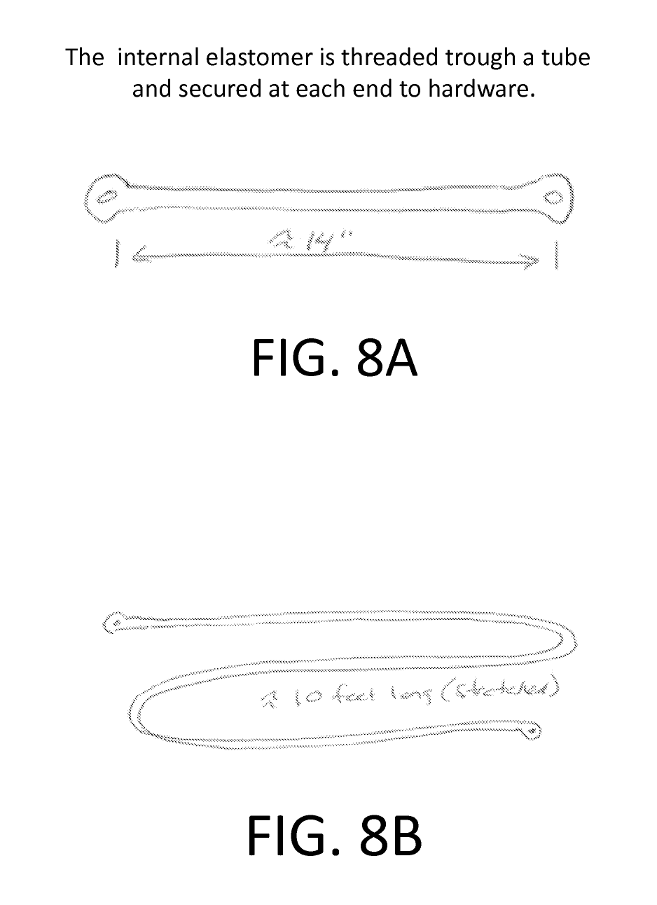

The use of elastomer in exemplary embodiments provides advantages other than for just avoiding tangling of the gathered leash body loops. FIGS. 8A and 8B show an exemplary elastomer. The elastomer is shown static or unstretched with a length of about 14 inches in FIG. 8A. The elastomer is shown stretched with a length of about 10 feet in FIG. 8B though the elastomer is not necessarily fully stretched in FIG. 8B. The elastomer might be made from a high stretch thermoplastic rubber (TPR), thermoplastic elastomer (TPE), or other similar material generally requiring a mold to cast or fabricate a part. TPR is not a material heretofore known to be used in the construction of pet leashes. Such a higher stretch with low force internal “elastic” component, including the possible use of loops molded into the ends that facilitate construction of the finished leash, may be provide the functioning disclosed herein, such as allowing the leash to be able to be gathered with the clip/loop combination and not create a tangle risk. For example, the leash could otherwise tangle under the feet of the pet and/or operator as in the case of conventional bungee-style leashes in the market, which offer only limited range of extension and retraction.

In exemplary embodiments disclosed herein, the leash may have a length of about 10 feet (or other reasonably long length). If the leash did not have a large extension/retraction range as disclosed herein, then it might otherwise be difficult and cumbersome for an operator to manage the slack and with the other hand clip, unclip, or re-clip onto the loops. Advantageously, exemplary embodiments disclosed herein may have at least about 4× or up to 6× or more stretch in the leash due to the elastomer material (e.g., TPR or TPE type material, etc.). In some exemplary embodiments, the TPR part itself can stretch as much as 8× or more, and is sufficiently durable for consumer products, which provides advantageous performance and consumer acceptance. An exemplary 10 foot leash retracting to under 3 feet (and even closer to 2 feet in some embodiments) enables using the leash with its full extended length without risk of tripping or tangling on the pet's feet, and enabling convenient changes between the 10 foot maximum length setting to other shorter settings (such as 3 or 7 feet).

Conventional leashes with an extra handle along the leash body (one at the normal distal end and a second somewhere mid-way on the leash body) do not function in the same manner as do exemplary embodiments disclosed herein. In contrast to the present disclosure, conventional leashes with two handles require two hands to operate to eliminate the slack and are not able to be set at a length, requiring the operator to always manage two handles in order to use a shorter leash. Further, the mid-body handle creates a real risk of the handle loop catching on objects when walking with the leash holding the distal end handle. When walking while holding the mid-body handle, the rear portion of the leash sags and forms quite a large leash loop that risks tangling or catching. Because of the latter issue, the maximum distance between the two handles in conventional leashes is generally limited to a length that when such a loop is formed it does not create a risk of getting tangled under the operator's or pet's feet or caught in other ways. For example, conventional leashes should not have more than 4 feet between the two handles, although even less than 4 feet in practice is generally desirable for consumer and pet owners that use the two-handled conventional leashes.

Exemplary embodiments disclosed herein may include a detachable handle and an extra clip at the distal end of the leash body. This allows for easy, quick, and simple conversion from a one-pet leash to a two-pet setup using the single leash. For this functionality, the combination of extra loops, clip, and the ability of the leash to contract to a fraction of its extended length both makes the conversion simple and more manageable in use. The extra clip at the distal end of the leash body is operable or function as the second pet attachment point to the second pet's collar. The light pressure and wide range of extension/retraction of the leash may also enable two pets to be walked without needing to manage the leash(es) nor worry about a leash tangling under foot and/or without the two leash lengths tangling which can significantly shorten their effective lengths. Further, exemplary embodiments may allow two full leashes to be combined with one handle to walk 3 or 4 pets by clipping the handle to two loops or rings along the body of the leash—one from each leash.

The features and elements disclosed herein (e.g., singly and/or as an overall combination, etc.) provide or permit a number of other additional functions not readily available in conventional leashes and/or that are less complicated and easier to use than conventional leashes. For example, exemplary embodiments of a leash disclosed herein may be secured around most trees and/or the user's waist/body and positively lock in place. If secured around the user's waist, the leash may be used totally hands-free while jogging or biking. The handle can be detached to reduce potential catching on things and generally avoid the bouncing handle while, for example, jogging—akin to a slip knot with the leash body clipped by the snap hook. The leash may also be used without the handle altogether for a more portable and compact leash just by using the extra built-in clip to form a small loop to serve as a handle by around the leash body or to clip onto one of the rings or just the leash body itself, thereby forming an extra loop in the leash that functions as an alternate handle to hold. The leash may also be clipped to a belt, backpack, car door handle, car bumper, etc. The leash may also clip to a carry bag, bottles or mugs with incorporated loops to clip onto, etc. In exemplary embodiments, the leash may include a key ring attached or incorporated into the handle to safely store keys and means to carry empty cleanup bags, for example.

The leash may be nearly non-sagging due to its lightweight materials and indirectly due to the use of the high stretch cast part from TPR elastomer. By stretching it so much, it makes for a significantly lighter weight per foot as compared to other conventional leashes.

Advantageously, the extra functionality disclosed herein may be provided without complexity and without additional parts that much be detached or added for specific functions, which thus avoids lost additional parts or temporary storage of those additional parts.

The construction and fabrication of exemplary embodiments of leashes disclosed herein are different than other conventional bungee or similar type leashes. For example, the cast elastomer part itself might be constructed with loops at each end, which loops may be built into the interior of the leash body. This can reduce time and cost as the loops enable threading through the sewn fabric tube more easily and quickly.

In an exemplary embodiment, the internal elastomer may be constructed of a single cast part of approximate length of 13 inches to 18 inches (after trimming/cutting the ends during fabrication) in order to form a leash that might have a maximum working or stretched length of up to about 10 feet. Such part might also be cast in a diameter of approximately ⅜ inches with loops at the opposite ends, which loops may aid in the fabrication and threading of the elastomer through the leash tube or body. The elastomer may have a diameter between about ¼ inch and ½ inch, which diameter would substantially shrink when stretched during both construction to thread the elastomer through the tube but also during extension of the leash.

The fabric leash body in an exemplary embodiment might have a width measured when the tube is flat of about 1 inch to 1.75 inch width or diameter fabric tube that enables the leash to contract sufficiently. A narrower tube might tend to bunch and resist compression or retraction.

The finished length of an exemplary leash might be 10 feet long, and retract to approximately 2 feet or more for larger/heavier pet leash with heavier fabric materials. An exemplary embodiment of this length might include two connection rings along the body, such as one connection ring placed approximately 3 feet from the spring hook connector at one end, and the other connection ring about 3 feet farther along the leash body. Such a construction may enable a leash working length to be set to 3, 4, 7, or 10 feet. It could also create a two-pet setup with each of the two lengths ranging from 3 to 7 feet (e.g., 3 and 7, 4 and 6, or 3 and 4 feet respectively, etc.).

As recognized by the inventor hereof, a conventional leash has slack when the pet stops walking or is walking in the “heel” position, or when a leash is mounted to an inanimate stationary object, such as a fence post, gate, etc. The slack in a leash may eventually end up tangled on objects (e.g., bushes, etc.), in between the pet's and/or pet walker's legs, causing potential harm to both the walker and pet and delays in exercising the pet. Or the leash slack may end up tangling the leash. Conventional leashes with incorporated hardware or built-in hardware have the potential problem with slack and also tend to have one or more of the following additional disadvantages: the incorporated hardware or built-in hardware damages the conventional leash, is permanently affixed to the conventional leash, adds weight, metal, or other material that can affect the pet and pet walker/owner, adds additional tension to the pet, and is geared to correct behavior.

Exemplary embodiments disclosed herein include an internal component that may comprise an elastomeric material (e.g., TPR, TPE, etc.) that permits significant extension with light resistance and then retraction, and which also manages the slack in the leash. In various exemplary embodiments, this internal part may be integrally molded from or comprise polyurethane, thermoplastic rubber, or thermoplastic resin, such as hydrogenated styrene isoprene/butadiene block copolymer, a block copolymer, etc. Accordingly, the internal component or adapter may thus be monolithically formed to have a single piece construction.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms, and that neither should be construed to limit the scope of the disclosure. In some example embodiments, well-known processes, well-known device structures, and well-known technologies are not described in detail. In addition, advantages and improvements that may be achieved with one or more exemplary embodiments of the present disclosure are provided for purpose of illustration only and do not limit the scope of the present disclosure, as exemplary embodiments disclosed herein may provide all or none of the above mentioned advantages and improvements and still fall within the scope of the present disclosure.

Specific dimensions, specific materials, and/or specific shapes disclosed herein are example in nature and do not limit the scope of the present disclosure. The disclosure herein of particular values and particular ranges of values for given parameters are not exclusive of other values and ranges of values that may be useful in one or more of the examples disclosed herein. Moreover, it is envisioned that any two particular values for a specific parameter stated herein may define the endpoints of a range of values that may be suitable for the given parameter (i.e., the disclosure of a first value and a second value for a given parameter can be interpreted as disclosing that any value between the first and second values could also be employed for the given parameter). For example, if Parameter X is exemplified herein to have value A and also exemplified to have value Z, it is envisioned that parameter X may have a range of values from about A to about Z. Similarly, it is envisioned that disclosure of two or more ranges of values for a parameter (whether such ranges are nested, overlapping or distinct) subsume all possible combination of ranges for the value that might be claimed using endpoints of the disclosed ranges. For example, if parameter X is exemplified herein to have values in the range of 1-10, or 2-9, or 3-8, it is also envisioned that Parameter X may have other ranges of values including 1-9, 1-8, 1-3, 1-2, 2-10, 2-8, 2-3, 3-10, and 3-9.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “includes,” “including,” “has,” “have,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

The term “about” when applied to values indicates that the calculation or the measurement allows some slight imprecision in the value (with some approach to exactness in the value; approximately or reasonably close to the value; nearly). If, for some reason, the imprecision provided by “about” is not otherwise understood in the art with this ordinary meaning, then “about” as used herein indicates at least variations that may arise from ordinary methods of measuring or using such parameters. For example, the terms “generally,” “about,” and “substantially,” may be used herein to mean within manufacturing tolerances. Whether or not modified by the term “about,” the claims include equivalents to the quantities.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section could be termed a second element, component, region, layer or section without departing from the teachings of the example embodiments.

Spatially relative terms, such as “inner,” “outer,” “beneath,” “below,” “lower,” “above,” “upper” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

The foregoing description of the embodiments has been provided for purposes of illustration and description. It is not intended to be exhaustive or to limit the disclosure. Individual elements, intended or stated uses, or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

1. A leash comprising a leash body and a handle attachable/detachable to/from the leash body, wherein the leash body is configured to be stretched and retracted.

2. The leash of claim 1, wherein:
the leash body comprises elastomer having a stretch ratio of 5:1 or more; and/or
the leash body comprises thermoplastic rubber or thermoplastic elastomer; and/or
the leash body is configured to stretch and extend to a length several times greater than a length of the leash body when contracted and at rest; and/or
the leash body is configured to stretch to an extended length of about 10 feet and retract from the extended length of about 10 feet to a retracted length of about 3 feet of less.

3. The leash of claim 1, wherein the leash body is configured such that a force required to extend the leash is relatively light in proportion to a pet's weight.

4. The leash of claim 1, wherein the leash body comprises:
an outer shell; and
elastomer within the shell.

5. The leash of claim 4, wherein:
the outer shell comprises ripstop nylon; and/or
the outer shell comprises a relatively thin, strong material having strong tensile strength and that can gather with a very light contraction force.

6. The leash of claim 1, further comprising:
a hardware connector at each end of the leash body; and/or
a spring hook at each end of the leash body.

7. The leash of claim 1, wherein the leash body includes one or more connection points along the leash body.

8. The leash of claim 7, wherein the one or more connection points comprise one or more rings attached along the leash body by threading the leash body through the one or more rings and tying the leash body into a half-knot to secure the one or more rings in place.

9. The leash of claim 7, wherein a detachable handle is connectible to any one of the one or more connection points along the leash body to convert the leash into a two-pet leash with the detachable handle connected at some point along the leash body other than at opposing ends of the leash.

10. The leash of claim 1, further comprising:
a hardware connector at each end of the leash body; and
one or more connection points or rings along the leash body;
whereby a maximum functional length of the leash when fully stretched may be shortened or altered by clipping one of the hardware connectors to a corresponding one of the one or more connection points or rings along the leash body to thereby create a gather or loop that shortens the functional length of the leash.

11. The leash of claim 1, further comprising:
a spring clip at each end of the leash body; and
one or more connection points or rings along the leash body;
whereby the spring clip at an operator end of the leash body is attachable to the leash body at the one of the connection points or rings to create a loop in the leash body, which loop may be attached around an object or used as a handle.

12. The leash of claim 1, wherein the leash body comprises an outer shell fabric sewn into a long tube with an elastomer threaded therethrough, and connecting hardware attached at each end of the leash body, and wherein one or more additional connecting points or rings are along the leash body.

13. The leash of claim 1, wherein the leash body comprises elastomer molded from one piece of material within a fabric tube, and wires, crimps or other means at opposing ends of the leash body.

14. The leash of claim 1, wherein the leash body comprises elastomer within a fabric tube, and wherein:
the elastomer has a length within a range from about 13 inches to about 18 inches; and/or
the elastomer has a diameter with a range from about ¼ inch to about ½ inch; and/or
the fabric tube has an extended length within a range from about 8 feet to about 12 feet and contracted length within a range from about of 18 inches to 40 inches; and/or
the fabric tube has a width measured when the tube is flat within a range from about 1 inch to about 1.75 inches.
